(19) United States
(12) Patent Application Publication
(10) Pub. No.: US 2006/0196816 A1
(43) Pub. Date: Sep. 7, 2006

(54) Chlorinator

(76) Inventor: Kenneth Dean Davis, College Station, TX (US)

Correspondence Address: ALLEN D. DARDEN, PO BOX 4412, BATON ROUGE, LA, 70821, US

(21) Appl. No.: 11/370,303

(22) Filed: Mar. 7, 2006

Related U.S. Application Data
(60) Provisional application No. 60/659,202, filed on Mar. 7, 2005.

(51) Int. Cl. B01D 15/00

(52) U.S. Cl. 210/198.1

(57) ABSTRACT

A chlorinator for treatment of water is connected to the outlet of a pump in a final treatment or collection tank of a water treatment system. The chlorinator includes a venturi chamber connected to a chlorine solution reservoir. When the pump is activated, water is passed through the venturi chamber, drawing chlorine solution into the final treatment tank. The pump causes pressure to increase in a hydraulic timer chamber, which controls a valve that stops the flow of water through the venturi chamber after the desired amount of chlorine solution is delivered to the final treatment tank. The time required for the pressure in the hydraulic timer chamber to increase sufficiently to cause the closing of the valve can be adjusted by altering the volume of the hydraulic timer chamber, or by changing the size of an orifice in the hydraulic timer chamber, such that the dosing of chlorine solution into the final treatment or collection tank can be finely adjusted.

### CROSS-REFERENCE TO RELATED APPLICATION

This application claims priority from U.S. Provisional Application No. 60/659,202, filed Mar. 7, 2005, by Kenneth Davis, entitled Chlorinator, which is incorporated herein by reference for all purposes.

### BACKGROUND OF THE INVENTION

1. Field of the Invention

This invention relates to the treatment of water to reduce the presence of bacteria and other undesirable contaminates, such that the water can be safely utilized or disposed to the environment. More particularly, the present invention concerns a system for automatically applying consistent amounts of a chemical solution to water to be treated.

2. Description of the Prior Art

Chlorinators for water treatment are known in the prior art. A typical waste water system includes a final treatment or collection tank containing a pump which periodically removes some of the treated water from the tank for use or disposal. Application of liquid chlorine solutions to final treatment tanks using a venturi chamber activated by such a pump can be seen in Braden U.S. Pat. No. 6,627,071, and Chaffin U.S. Pat. No. 6,932,912. Proper “dosing” of the water in the final treatment or collection tank with a disinfectant solution is vital. Too little of the disinfectant solution and the water may not be free of bacteria. Too much of the disinfectant solution may cause problems in the use or disposal of the water after treatment. Prior art chlorinators are unable to provide an amount of disinfectant solution to the water being treated in a reliable, consistent, and easily adjustable manner.

### SUMMARY OF THE INVENTION

The chlorinator of the present invention is typically located in a tank containing water that is being treated. Such tanks may be the final treatment tank in a sewage treatment system, sometimes referred to as a “collection” tank in the industry. The tank often contains a pump used to periodically pump treated water out of the tank. The chlorinator comprises a body which is a cross-shaped conduit with four openings. One of the openings of the body is connected to a sampling port, which is located in the upper portion of the final treatment or collection tank. The body receives water from the pump utilized to pump treated water out of the tank. The pump is periodically activated, pumping the water from the final treatment tank through the body of the chlorinator, to whatever ultimate disposal means is being employed such as a sprinkler field or a subterranean piping system. The body of the chlorinator can be 1″ schedule 40 PVC pipe. The size of the piping used will depend upon the volume of water to be treated. The sampling port is further comprised of a valve, such that when the pump is activated, opening of the valve will enable a sample of the water in the final treatment tank to be obtained.

The body of the chlorinator is connected to a control valve. When open, the control valve allows water that is being pumped into the body of the chlorinator to pass through the control valve. The outlet of the control valve is connected to a venturi chamber. The outlet of the venturi chamber is in communication with the water in the final treatment tank. The suction orifice of the venturi chamber is connected to a reservoir containing the chemical being used to treat the water in the final treatment tank. In most applications this will be a 6% aqueous solution of sodium hypochlorite. When water passes through the venturi chamber, the reduced pressure at the suction orifice causes liquid to be drawn from the reservoir and into the final treatment or collection tank.

The control valve is operated by increasing the pressure in a hydraulic timing chamber connected to the control valve. The pressure in the hydraulic timing chamber is varied by connecting the chamber to the body of the chlorinator via a control tubing. The control tubing is connected to the body of the chlorinator near the upper most connection of the body, typically the connection which is connected to the sampling port. When the pump is activated water flows to the body of the chlorinator, through the control tubing and into the hydraulic timing chamber. As the hydraulic timing chamber fills with water, the pressure in the chamber increases, and is transferred to the control valve via a pressure sensing port on the valve. When the pressure reaches the set point of the control valve, the valve closes.

The control valve is in the open position while the pump is off. When the pump is activated, either by a timer, or by the water level in the final treatment tank reaching a high set point, water begins to flow into the body of the chlorinator. Water also flows through the control valve and through the venturi chamber, creating a lower pressure at the venturi chamber suction orifice, causing the chemical treatment solution to be pulled from the reservoir and into the water in the final treatment tank. At the chlorinator body water also enters the control tubing. Water moves through the control tubing to the hydraulic timing chamber, increasing the pressure in the chamber. When the pressure at the pressure sensing port on the valve reaches the pressure set point, the control valve closes, and water no longer can flow through the control valve and venturi chamber, thereby stopping the flow of chlorine solution from the reservoir. When the water level in the final treatment or collection tank reaches the low set point the pump turns off (or, if the pump is on a timer, when the time expires). The pressure in the chlorinator body is thereby reduced, and the pressure in the hydraulic timer chamber equalizes with the pressure in the chlorinator body via the control tubing. Once the pressure in the hydraulic timing chamber drops below the control valve set point, the control valve opens, and the chlorinator is ready for another cycle of the pump.

The time required to achieve a pressure change sufficient to cause the control valve to close can be varied by the varying the volume of the hydraulic timing chamber. The larger the chamber, the more time required for the pressure to build when the pump is activated. The longer the control valve is open, the greater the “dosage” of chlorine solution that will be pulled from the reservoir and into the final treatment tank. The time required for the pressure to increase adequately to activate the control valve can also be adjusted by placing a small orifice in the hydraulic timing chamber. This orifice is usually contained within a flush port fitting in the bottommost portion of the hydraulic timing chamber. The larger the orifice in the flush port fitting the more water that will escape from the hydraulic timing chamber during the time period that the pump is activated. The more water that escapes the hydraulic timing chamber, the longer it will take the pressure to increase in the chamber. This results in the control valve being open a longer period of time, and a higher dosage of chlorine solution being pulled from reservoir. Changing the size of the orifice in the flush port fitting is generally used to cause small adjustments to the dosage of chlorine solution. Changing the volume of the hydraulic timing chamber is generally used to cause larger adjustments to the dosage of chlorine solution.

Once the pump turns off, the pressure in the chamber equalizes with the pressure in the chlorinator body via the control tubing. The hydraulic timer chamber returns to the same beginning pressure point each time the pump turns off, that being the pressure in the chlorinator body. Accordingly, the amount of pressure increase needed to activate the control valve should be the same each time the pump turns on, since the starting pressure should be the same, and the set point pressure in the control valve should not change. Accordingly, the dosage of chlorine provided to the final treatment tank should be the same each time the pump cycles. Since the pump should remove the same volume of water each time it cycles, the chlorine in the final treatment tank is maintained at the same level.

Solids can be prevented from entering the hydraulic timing chamber by installing a filter on the end of the control tubing in the chlorinator body. The openings in the filter should be smaller than the orifice used in the flush port fitting. In this manner, any solids that do get past the filter should also be able to pass through the orifice in the flush port fitting. The chlorinator should be manufactured from materials that are resistant to the levels of chlorine to which the various parts of the chlorinator are subjected. However, only the reservoir, venturi chamber, and connecting conduit are subjected to the undiluted chlorine solution. All other parts of the chlorinator are not subjected to the full strength of the chlorine solution. These parts are only subjected to the air or water in the final treatment tank, with its lower levels of chlorine.

Various chemical solutions can be utilized in the reservoir, depending upon the application. The most commonly used material for treatment of water will be a 6% aqueous solution of chlorine, commonly sold as household bleach. Stronger or weaker solutions may be used, and other chemical solutions may be used, depending upon a particular application. The use of the chlorinator is not limited to sewage treatment applications. Any water treatment application needing consistent dosages of chlorine or other chemical disinfectants can utilize this invention, including treatment of potable water.

### BRIEF DESCRIPTION OF THE DRAWINGS

FIG. 1 of the drawings is a schematic illustration showing a preferred embodiment of the present invention.

FIG. 2 of the drawings is a cutaway illustration showing the filter of a preferred embodiment of the present invention.

### DETAILED DESCRIPTION OF THE PREFERRED EMBODIMENT

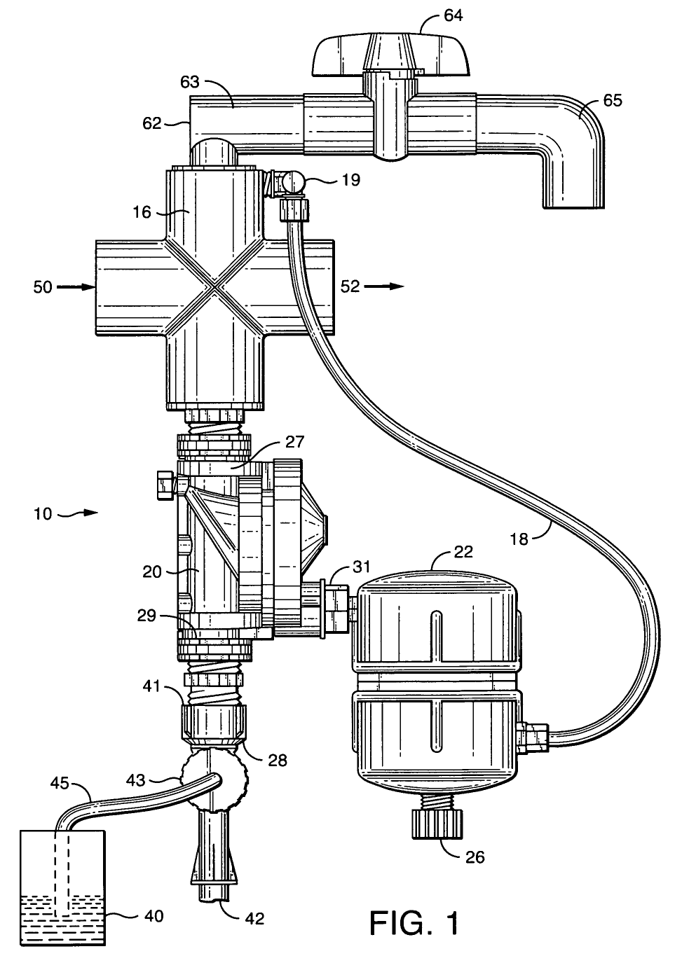

Referring to FIG. 1, a Chlorinator embodying the features of the present invention is shown generally at 10. The Chlorinator 10 is typically located in a tank containing water that is being treated using the Chlorinator 10. Such tanks may be the final treatment tank in a sewage treatment system, sometimes referred to as a “collection” tank in the industry. The tank often contains a pump used to periodically pump treated water out of the tank. The Chlorinator 10 is usually located in the upper portion of such a tank, in the air space above the liquid level in the tank, but may also be located below the liquid level.

The Chlorinator comprises a body 16, which is a cross-shaped conduit with four openings. One of the openings of the body 16, typically the upper most opening, is connected to a sampling port 62. The sampling port 62 is located in the upper portion of the final treatment or collection tank, or in a riser portion of such a tank extending above the main body of the tank. The body 16 also receives water from the pump generally located within the final treatment or collection tank containing the water being treated by the Chlorinator 10. The final treatment or collection tank of most sewage treatment systems contains or utilizes a pump to pump treated water out of the tank. The pump is periodically activated, pumping the water from the final treatment tank to whatever ultimate disposal means is being employed. This could be to a sprinkler field or to a subterranean piping system. This pump may be on a timer, or connected to a float switch, such that it is activated when the water in the final treatment tank reaches a certain height, and is deactivated when the water level is reduced to a preset point. The outlet of the pump is connected to the inlet 50 of the body 16 of the Chlorinator 10. Water exits the body 16 through the outlet 52, and is directed to whatever disposal method is being utilized for the system utilizing the Chlorinator 10. The body 16, for many applications, can be 1″ schedule 40 PVC pipe. However, the size of the piping used will depend upon the volume of water to be treated. In the preferred embodiment the inlet 50 and outlet 52 may be reversed, to facilitate the installation of the Chlorinator 10.

The sampling port 62 is further comprised of a valve 64, and two 90 degree elbows 63 and 65. When the pump is activated, opening of the valve 64 will enable a sample of the water in the final treatment tank to be obtained. Obviously, there are many configurations for a sampling port 62. The sampling port 62 should be easily accessible. The Chlorinator 10 can be utilized without a sampling port 62 if such a port is not required by the jurisdiction in which the Chlorinator 10 is being utilized. In the typical application where the Chlorinator body 16 is located within a final treatment or collection tank, the sampling port 62 will extend into the riser section of that tank, such that it is easily accessible, but still protected from damage.

As discussed above, the body 16 is in the shape of a cross, with sampling port 62 connected to one of the four available connection points. An inlet 50 of the body 16 is connected to a pump outlet, and occupies another of the four available connection points. An outlet 52 of the body 16 is connected to the ultimate water disposal means for the sewage treatment system, and occupies a third of the four available connection points. The fourth available connection point on the body 16 is connected to a control valve 20. When open, the control valve 20 allows water that is being pumped into inlet 50 of the body 16 to exit the body 16 and pass through the control valve 20. When the control valve 20 is closed, no water can pass through that connection point of the body 16. In practice, when the pump is activated, water can pass directly through the body 16 from inlet 50 to outlet 52. If the valve 64 in sample port 62 is opened, then a portion of the water flow will pass through the sample port 62 until the valve 64 is closed. If the control valve 20 is open, then a portion of the water flow will pass through control valve 20. The amount of water that passes through the sample port 62, if valve 64 is open, and the amount of water that passes through control valve 20 if control valve 20 is open, will depend upon the relative pressures present at each of the three connections of the body 16 out of which water passes.

The control valve 20 has an inlet 27 and an outlet 29. As described above, the inlet 27 of control valve 20 is connected to one of the connection points of body 16. In a typical application this will be the connection point of body 16 which is oriented in a downward direction. The various connections to the body 16, including the inlet 50 connection to the pump, the outlet 52 connection to the means of disposal of the water, the connection to the sample port 62, and the connection to the control valve inlet 27 may be by any suitable method, including threaded connections, or gluing using an appropriate solvent and pipe nipple as is common in PVC applications.

The outlet 29 of control valve 20 is connected to a venturi chamber 28. As is well known in the art, a venturi chamber is designed to reduce the pressure of a fluid traveling through the chamber, by reducing the area through which the fluid can pass. This increases the speed of the fluid passing through that area, reducing the pressure of the fluid at that point. The venturi chamber 28 has three openings. An inlet 41 is connected to the outlet 29 of the control valve 20. The outlet 42 of the venturi chamber 28 is in communication with the water in the final treatment tank. This is typically accomplished by simply placing the Chlorinator 10 into the final treatment or collection tank. The outlet 42 of the venturi chamber 28 is directed towards the water in the final treatment tank, and may be above or below the water level in the tank. The venturi chamber 28 may be directly adjacent to the control valve 20, or may be spaced some distance from the control valve 20 using PVC pipe, depending upon the needs of a particular application.

The third opening of the venturi chamber 28 is the suction orifice 43. The venturi effect described above causes reduced pressure at suction orifice 43 when fluid is passing through the venturi chamber 28. The suction orifice 43 is connected via conduit 45 to a reservoir 40 containing the chemical being used to treat the water in the final treatment tank. In most applications this will be an aqueous solution of sodium hypochlorite, commonly referred to as bleach, and readily obtainable. A 6% solution may be used, or weaker or stronger solutions of sodium hypochlorite, depending upon the application. When water passes through the venturi chamber 28, the reduced pressure at the suction orifice 43 causes liquid to be drawn from the reservoir 40, and into the water flow passing through the venturi chamber 28. The pressure drop created by venturi chambers varies with the characteristics of the chamber and the flow rate of the fluid through the chamber. Various venturi chambers 28 can be used in the present invention, depending upon the needs of the application. Higher viscosity treatment chemicals, such as higher percentage solutions of sodium hypochlorite, may require venturi chambers 28 that create increased pressure reductions. Increased distance between the reservoir 40 and the venturi chamber 28 may also require increased pressure reduction at the suction orifice 43.

The connection between the suction orifice 43 and the reservoir 40 is conduit 45, which can be tubing that is resistant to the corrosive effects of the chemical in the reservoir 40 being used to treat the water. The reservoir 40 can be located within the final treatment tank, or external to the final treatment tank. The reservoir 40 should be easily accessible such that it can be refilled as needed. It should be sized such that a single charge of solution will last an adequate time to prevent overly frequent maintenance. The reservoir 40 may be of any configuration, including reservoir vessels that are primarily vertically aligned or horizontally aligned. The size and length of conduit 45 will impact the amount of chemical that is pulled from the reservoir, and, accordingly, can be altered to change the dosing of chemical solution delivered to the final treatment tank with each cycle of the pump.

The operation of the control valve 20 is controlled by a hydraulic timing chamber 22. The operation of control valve 20 depends upon the pressure applied to control valve 20 through a pressure sensing port 31. Typically, such valves contain a diaphragm that causes the valve to close when the pressure applied to one side of the diaphragm through a pressure sensing port 31 increases to a certain set point. The pressure sensing port 31 of control valve 20 is connected to the hydraulic timing chamber 22, and thus it is the pressure within the hydraulic timing chamber 22 that controls the operation of the control valve 20. The operational pressure in the hydraulic timing chamber 22 varies across the range of pressures which activates the operation of control valve 20. The pressure in the hydraulic timing chamber is varied by connecting the hydraulic timing chamber 22 to the body 16 of the Chlorinator 10 via control tubing 18. The control tubing 18 is connected to the body 16 near the upper most connection of the body 16, typically the connection which is connected to the sampling port 62. The connection is accomplished by creating an orifice in the side of body 16 into which a tubing fitting, preferably a 90 degree tubing elbow 19, is fixably inserted.

The control tubing 18, connecting body 16 to the hydraulic timing chamber 22, accommodates the transfer of water from the body 16 to the hydraulic timing chamber 22. When the pump is activated, and water flows through the body 16, it also flows through control tubing 18 and into hydraulic timing chamber 22. As the hydraulic timing chamber 22 fills with water, the pressure in the chamber 22 increases, and is transferred to the control valve 20 via the pressure sensing port 31. When the pressure reaches the set point of the control valve 20, the valve switches modes. Typically the control valve 20 is open at low pressures, and closes as the pressure increases past the set point of the control valve 20. The hydraulic timing chamber 22 can be manufactured in any suitable manner, including the use of readily available PVC fittings, such as two end caps connected together on a short PVC pipe nipple. The required openings in the hydraulic timing chamber 22 can then be machined into the walls of the chamber 22.

In operation, the control valve 20 is in the open position while the pump is off. When the pump is activated, either by a timer, or by the water level in the final treatment tank reaching a high set point, as discussed above, water begins to flow into the body 16 of the Chlorinator 10. Water also flows through the control valve 20 and through the venturi chamber 28, creating a lower pressure at suction orifice 43, causing the chemical treatment solution to be pulled from the reservoir 40 via conduit 45 and into the water flow through the venturi chamber 28 and out of the outlet 42 into the final treatment tank. At the body 16 water also enters the control tubing 18 via the orifice in body 16 into which tubing elbow 19 has been inserted. Water moves through control tubing 18, to hydraulic timing chamber 22, increasing the pressure in hydraulic timing chamber 22. When the pressure at the pressure sensing port 31 reaches the control valve 20 set point, the control valve 20 closes, and water no longer can flow through the control valve 20 and venturi chamber 28, thereby stopping the flow of chlorine solution since the venturi effect ceases when the water stops flowing. A small hole is placed in the conduit 45 in an airspace above in the reservoir 40 to prevent any siphoning of chlorine solution after control valve 20 closes. When the water level in the final treatment or collection tank reaches the low set point the pump turns off (or, if the pump is on a timer, when the time expires). The pressure in body 16 is thereby reduced, and the pressure in hydraulic timer chamber 22 equalizes with the pressure in body 16 via control tubing 18. Once the pressure in hydraulic timing chamber 22 drops below the control valve 20 set point, the control valve 20 opens, and the Chlorinator 10 is ready for another cycle of the pump. In many applications, when the pump is activated, the control valve 20 is open for a relatively short time, as compared to the length of time the pump is running. For example, the control valve 20 may be open for 5 to 10 seconds, meaning that the chlorine solution is pulled from the reservoir 40 for only 5 to 10 seconds per cycle of the pump. The pump will continue running for several minutes after the closing of the control valve 20 to lower the water level in the final treatment tank.

The time required for the pressure in the hydraulic timing chamber 22 to change enough to close the control valve 20 depends upon an number of factors. The characteristics of the control valve 20 are obviously important. A control valve 20 must be selected that can be responsive to the type of pressure changes that are reasonably obtainable given the characteristics of pumps used in typical sewage treatment system known in the art. The time required to achieve a pressure change sufficient to cause the control valve 20 to close can be varied by the varying the size of the hydraulic timing chamber 22. The larger the chamber 22, the more time required for the pressure to build when the pump is activated. The longer the control valve is open, the greater the “dosage” of chlorine solution that will be pulled from the reservoir 40 and into the final treatment tank. Changing the volume of the hydraulic timing chamber 22 can significantly change the time required for the pressure to reach the control valve 20 set point. Connecting the hydraulic timing chamber 22 to the pressure sensing port 31 with a threaded connection will facilitate changing out the hydraulic timing chamber 22 with one of larger or smaller volume.

The time required for the pressure to increase adequately to activate the control valve 20 can also be adjusted by placing a small orifice in the hydraulic timing chamber 22. This orifice is usually contained within a flush port fitting 26 in the bottommost portion of the hydraulic timing chamber 22. The flush port fitting 26 may be a threaded fitting that closes an opening in the bottom of the hydraulic timing chamber 22. The opening may be needed during maintenance of the Chlorinator 10 should the hydraulic timing chamber 22 become clogged. Unscrewing the flush port 26 provides access to the inside of the hydraulic timing chamber 22 such that it may be cleaned of any debris or solids. A small orifice in the flush port fitting 26 can be used to adjust the time required for the pressure in the hydraulic timing chamber 22 to increase enough to activate the control valve 20. The larger the orifice in the flush port fitting 26, the more water that will escape from the hydraulic timing chamber 22 during the time period that the pump is activated. The more water that escapes the hydraulic timing chamber 22, the longer it will take the pressure to increase in the chamber 22. This results in the control valve 20 being open a longer period of time, and a higher dosage of chlorine solution being pulled from reservoir 40. Obviously, the orifice in the hydraulic timing chamber must not be so large that the pressure in the chamber cannot reach the activation set point of the control valve 20. Changing the size of the orifice in the flush port fitting 26 is generally used to cause small adjustments to the dosage of chlorine solution. Changing the volume of the hydraulic timing chamber 22 is generally used to cause larger adjustments to the dosage of chlorine solution.

Alternatively, the small orifice in the flush port fitting 26 can be simply placed in the wall of the hydraulic timing chamber 22. However, placement of the orifice in the removable flush port fitting 26 enables the user to adjust the time required for activation of the control valve 20, and thereby adjust the “dosage” of chlorine solution pulled into the final treatment tank. If an increased dosage is desired, then a new flush port fitting 26 with a larger orifice can be placed in the hydraulic timing chamber 22. A larger orifice will cause the hydraulic timing chamber 22 to take a longer time to increase pressure to the point where the control valve 20 is activated. If a smaller dosage of chlorine solution is desired, then a flush port fitting 26 with a smaller orifice can be installed in the hydraulic timing chamber 28, thereby reducing the time required to reach the control valve 20 set pressure, and reducing the dosage of chlorine solution pulled into the final treatment tank.

The hydraulic timing chamber 22 will function even without an orifice in the flush port fitting 26. Although an orifice in the flush port fitting 26 may allow for some or all of the liquid in the hydraulic timing chamber 22 to drain from the chamber through the orifice when the pump is off, the draining of the liquid is not necessary to the function of the hydraulic timing chamber 22. Once the pump turns off, the pressure in the chamber 22 equalizes with the pressure in the body 16 via the control tubing 18, regardless of whether there is an orifice in the flush port fitting 26. The hydraulic chamber 22 returns to the same beginning pressure point each time the pump turns off, that being the pressure in the body 16. Accordingly, the amount of pressure increase needed to activate the control valve 20 should be the same each time the pump turns on, since the starting pressure should be the same, and the set point pressure in the control valve 20 should not change. Accordingly, the dosage of chlorine provided to the final treatment tank should be the same each time the pump cycles. Since the pump should remove the same volume of water each time it cycles, the chlorine in the final treatment tank is maintained at the same level.

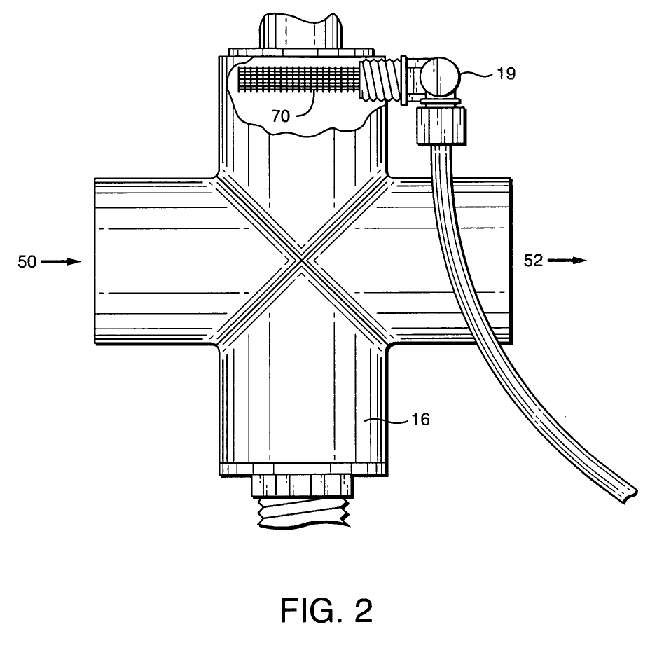

It is important to avoid having solids enter the hydraulic timing chamber 22. If solids do enter the chamber, they could clog up the orifice in the flush port fitting 26, and defeat the timing adjustment created by use of the appropriate sized orifice, thereby altering the dosage of chlorine applied to the final treatment tank. One way to prevent the entry of solids into the hydraulic timing chamber 22 is to put a filter 70, shown in FIG. 2, on the 90 degree tubing elbow 19, such that the solids never can enter the control tubing 18. The openings in the filter 70 should be smaller than the orifice used in the flush port fitting 26. In this manner, any solids that do get past the filter 70 should also be able to pass through the orifice in the flush port fitting 26. Placing the filter 70 on the inlet side of the 90 degree tubing elbow 19, in the top portion of the body 16, also provides a method for cleaning collected solids off of the filter 70. When the valve 64 of the sampling port 62 is opened, water passes the filter 70 and acts to remove solids from the surface of the filter 70. If the filter 70 becomes clogged to the point where this method is not working, the 90 degree tubing elbow 19 can be removed and replaced. A threaded connection between the 90 degree tubing elbow 19 and the body 16 will facilitate removal and replacement of the filter 70.

The Chlorinator 10 should be manufactured from materials that are resistant to the levels of chlorine to which the various parts of the Chlorinator 10 are subjected. However, it should be noted that only the conduit 45 and venturi chamber 28 are subjected to the undiluted chlorine solution. All other parts of the Chlorinator 10, including particularly the parts responsible for governing and adjusting the dosage of chlorine solution, are not subjected to the full strength of the chlorine solution. Instead, these parts are only subjected to the air or water in the final treatment tank, with its lower levels of chlorine.

Various chemical solutions can be utilized in the reservoir 40, depending upon the application. As suggested above, the most commonly used material for treatment of water will be an aqueous solution of chlorine. This is usually prepared by mixing sodium hypochlorite with water. A 6% solution is generally used, and is commonly sold as household bleach. Stronger or weaker solutions may be used. Other hypochlorite salts may be used, such as calcium hypochlorite; and other disinfecting materials may be used, such as bromine. What chemical works best will depend upon a particular application. However, for most sewage treatment applications, use of common household bleach will facilitate maintenance and performance of the Chlorinator 10. The use of the Chlorinator 10 is not limited to sewage treatment applications. Any water treatment application needing consistent dosages of chlorine or other chemical disinfectants can utilize this invention, including treatment of potable water.

As will be readily apparent to those skilled in the art, the present invention may be produced in other forms without departing from its spirit or essential characteristics. The described embodiment is, therefore, considered as merely illustrative and not restrictive, the scope of the invention being indicated by the following claims rather than the detailed description of the preferred embodiment.

I claim:

1. A chlorinator for use in water treatment systems utilizing an outlet pump with outlet pump conduit and treatment tank, comprising:
a control valve with an inlet, outlet, pressure sensing port, and pressure set point, said control valve inlet being connected to a outlet pump conduit in a water treatment system, and said control valve changing from open to closed mode when the pressure at said pressure sensing port increases to said pressure set point;
a reservoir for housing disinfectant solution;
a venturi chamber with an inlet, an outlet, and a suction orifice; said venturi chamber inlet in communication with said outlet of said control valve, said suction orifice in communication with said reservoir for housing disinfectant solution, and said venturi chamber outlet in communication with the treatment tank of a water treatment system, whereby disinfectant solution is drawn from said reservoir into said venturi chamber when said control valve is open and the water treatment system outlet pump is activated; and
a pressure chamber in communication with said pressure sensing port of said control valve and also in communication with the outlet pump conduit, whereby the pressure in said pressure chamber increases to said control valve pressure set point after said outlet pump is activated.

2. A chlorinator for use in water treatment systems utilizing an outlet pump with outlet pump conduit and treatment tank, as in claim 1, further comprising:
a sampling port in communication with the outlet pump conduit, said sampling port further comprising a valve.

3. A chlorinator for use in water treatment systems utilizing an outlet pump with outlet pump conduit and treatment tank, as in claim 1, wherein said communication between said pressure chamber and the outlet pump conduit further comprises a filter to prevent solids from entering said pressure chamber.

4. A chlorinator for use in water treatment systems utilizing an outlet pump with outlet pump conduit and treatment tank, as in claim 1, further comprising;
an orifice in said pressure chamber, whereby the rate of pressure increase in said pressure chamber can be adjusted by varying the size of said orifice in said pressure chamber.

5. A chlorinator for use in water treatment systems utilizing an outlet pump with outlet pump conduit and treatment tank, as in claim 4, further comprising;
a flush port fitting connected to said pressure chamber, whereby said pressure chamber can be cleaned.

6. A chlorinator for use in water treatment systems utilizing an outlet pump with outlet pump conduit and treatment tank, as in claim 1, further comprising;
a flush port fitting connected to said pressure chamber, whereby said pressure chamber can be flushed out, and an orifice in said flush port fitting, whereby the rate of pressure increase in said pressure chamber can be adjusted by varying the size of said orifice in flush port fitting.

7. A chlorinator for use in water treatment systems utilizing an outlet pump with outlet pump conduit and treatment tank, as in claim 6, wherein said communication between said pressure chamber and the outlet pump conduit further comprises a filter to prevent solids from entering said pressure chamber.

8. A chlorinator for use in water treatment systems utilizing an outlet pump with outlet pump conduit and treatment tank, comprising:
a main body conduit with an inlet and a plurality of outlets, located in the outlet pump conduit line in a water treatment system;
a control valve with an inlet, outlet, pressure sensing port, and pressure set point, said control valve inlet being connected to one of said plurality of main body conduit outlets, and said control valve changing from open to closed mode when the pressure at said pressure sensing port increases to said pressure set point;
a reservoir for housing disinfectant solution;
a venturi chamber with an inlet, an outlet, and a suction orifice; said venturi chamber inlet in communication with said outlet of said control valve, said suction orifice in communication with said reservoir for housing disinfectant solution, and said venturi chamber outlet in communication with the treatment tank of a water treatment system, whereby disinfectant solution is drawn from said reservoir into said venturi chamber when said control valve is open and the water treatment system outlet pump is activated; and
a pressure chamber in communication with said pressure sensing port of said control valve and also in communication with said main body conduit, whereby the pressure in said pressure chamber increases to said control valve pressure set point after said outlet pump is activated.

9. A chlorinator for use in water treatment systems utilizing an outlet pump with outlet pump conduit and treatment tank, as in claim 8, further comprising:
a sampling port being connected to one of said plurality of main body conduit outlets, said sampling port further comprising a valve.

10. A chlorinator for use in water treatment systems utilizing an outlet pump with outlet pump conduit and treatment tank, as in claim 8, wherein said communication between said pressure chamber and said main body conduit further comprises a filter to prevent solids from entering said pressure chamber.

11. A chlorinator for use in water treatment systems utilizing an outlet pump with outlet pump conduit and treatment tank, as in claim 10, wherein said filter is located within said main body conduit.

12. A chlorinator for use in water treatment systems utilizing an outlet pump with outlet pump conduit and treatment tank, as in claim 8, further comprising;
a flush port fitting connected to said pressure chamber, whereby said pressure chamber can be flushed out, and
an orifice in said flush port fitting, whereby the rate of pressure increase in said pressure chamber can be adjusted by varying the size of said orifice in flush port fitting.

13. A chlorinator for use in water treatment systems utilizing an outlet pump with outlet pump conduit and treatment tank, as in claim 8, whereby the rate of pressure increase in said pressure chamber can be adjusted by varying the volume of said pressure chamber.

14. A chlorinator for use in water treatment systems utilizing an outlet pump with outlet pump conduit and treatment tank, comprising:
a main body conduit in the form of a cross, having an inlet and three outlets, said inlet and one of said outlets being connected in-line in the outlet pump conduit in a water treatment system;
a control valve with an inlet, outlet, pressure sensing port, and pressure set point, said control valve inlet connected to one of said outlets of said main body conduit, and said control valve changing from open to closed mode when the pressure at said pressure sensing port increases to said pressure set point;
a reservoir for housing disinfectant solution;
a sampling port connected to one of said outlets of said main body conduit, said sampling port further comprising a valve;
a venturi chamber with an inlet, an outlet, and a suction orifice; said venturi chamber inlet in communication with said outlet of said control valve, said suction orifice in communication with said reservoir for housing disinfectant solution, and said venturi chamber outlet in communication with the treatment tank of a water treatment system, whereby disinfectant solution is drawn from said reservoir into said venturi chamber when said control valve is open and the water treatment system outlet pump is activated;
a pressure chamber in communication with said pressure sensing port of said control valve and also in communication with said outlet of said main body conduit connected to said sampling port, whereby the pressure in said pressure chamber increases to said control valve pressure set point after said outlet pump is activated;
a flush port fitting connected to said pressure chamber, whereby said pressure chamber can be flushed out, and
an orifice in said flush port fitting, whereby the rate of pressure increase in said pressure chamber can be adjusted by varying the size of said orifice in flush port fitting.

15. A chlorinator for use in water treatment systems utilizing an outlet pump with outlet pump conduit and treatment tank, as in claim 14, whereby the rate of pressure increase in said pressure chamber can be adjusted by varying the volume of said pressure chamber.

16. A chlorinator for use in water treatment systems utilizing an outlet pump with outlet pump conduit and treatment tank, as in claim 14, whereby said chlorinator is contained within the treatment tank of a water treatment system.

17. A chlorinator for use in water treatment systems utilizing an outlet pump with outlet pump conduit and treatment tank, as in claim 14, wherein said reservoir contains a solution of sodium hypochlorite.

18. A chlorinator for use in water treatment systems utilizing an outlet pump with outlet pump conduit and treatment tank, as in claim 14, wherein said communication with said reservoir for housing disinfectant solution comprises tubing connected to said suction orifice and to said reservoir, and further wherein an anti-siphon orifice is located in said tubing in said reservoir.
